(19) United States
(12) Patent Application Publication
(10) Pub. No.: US 2007/0030307 A1
(43) Pub. Date: Feb. 8, 2007

(54) Print head, inkjet image forming apparatus, and method of compensating for a malfunctioning nozzle in the same

(75) Inventor: Jin-wook Jeong, Yongin-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/483,764

(22) Filed: Jul. 11, 2006

(30) Foreign Application Priority Data
Aug. 5, 2005 (KR) 2005-71695

(51) Int. Cl. B41J 2/16; B41J 2/14

(52) U.S. Cl. 347/47

(57) ABSTRACT

A printhead, an inkjet image forming apparatus, and a method of compensating for a malfunctioning nozzle for the same. The printhead includes a nozzle unit having a nozzle array to eject ink on a print medium to print an image and having a length that corresponds to a width of the print medium, and a compensating nozzle unit having a compensating nozzle array to eject a compensating solution on the print medium to compensate the image by diffusing the ink ejected from the nozzle unit and being installed parallel to the nozzle array in a direction that is perpendicular to a transferring direction of the print medium, wherein each nozzle disposed in the compensating nozzle array is positioned at a predetermined position between nozzles disposed in the nozzle array. The inkjet image forming apparatus and the method of compensating for a malfunctioning nozzle uses compensating solution droplets ejected from the compensating nozzle unit to compensate for the malfunctioning nozzle to prevent printing image degradation, such as the appearance of white lines that can be easily seen. The inkjet image forming apparatus performs a printing operation by changing a compensation process based on a type of the print medium, thereby obtaining optimum printing quality.

### CROSS-REFERENCE TO RELATED APPLICATIONS

This application claims the benefit of Korean Patent Application No. 10-2005-0071695, filed on Aug. 5, 2005, in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus, and more particularly, to an inkjet image forming apparatus which can compensate for image defects caused by malfunctioning nozzles and a method of compensating for malfunctioning nozzles in the same.

2. Description of the Related Art

In general, an inkjet image forming apparatus forms images by ejecting ink from a printhead, which is positioned a predetermined distance apart from a print medium and reciprocally moves in a direction that is perpendicular to a transferring direction of the print medium. This inkjet image forming apparatus is a shuttle type inkjet image forming apparatus. A nozzle unit having a plurality of nozzles for ejecting ink is installed in the printhead.

Recently, a printhead having a nozzle unit with a length that corresponds to a width of the print medium has been used to obtain high-speed printing. An image forming apparatus having this type of printhead is a line printing type inkjet image forming apparatus.

In a conventional line printing type inkjet image forming apparatus, the printhead is fixed and only a print medium is transferred. Accordingly, each nozzle disposed in the printhead ejects ink onto a fixed area of the print medium. Thus, when a nozzle malfunctions, a visible unprinted line, such as a white line, is shown on the print medium.

FIG. 1 illustrates printing patterns that are formed when a nozzle unit of the conventional line printing type inkjet image forming apparatus malfunctions. FIGS. 2A through 2D are pixel images used to explain a conventional method of compensating for a malfunctioning nozzle of the line printing type inkjet image forming apparatus.

Referring to FIG. 1, the conventional inkjet image forming apparatus forms an ink I image on the print medium by ejecting ink from nozzles 82 formed in a nozzle unit 80. The conventional nozzle unit 80 is installed along the direction that is perpendicular to the transferring direction of the print medium. Thus, when a nozzle 84 malfunctions, a visible unprinted line, such as a white line, is shown on the print medium. This printing defect typically does not matter when an image of a low printing density is formed. However, when printing a solid pattern or an image of a high printing density, the white line appears in the printed image along the transferring direction of the print medium, thereby substantially affecting the printing quality.

A shuttle type inkjet image forming apparatus prints an image in an overlapping manner by reciprocally moving a carriage several times to compensate for a printing quality degradation that results from a malfunctioning nozzle. This method is known as a shingling method. In contrast, in the line printing type inkjet image forming apparatus, the printhead is installed perpendicular to the transferring direction of a print medium, and does not reciprocally move along the print medium. That is, each nozzle in the printhead prints one pixel. If the nozzle malfunctions at a particular moment, a white unprinted line is generated on a region where the printing is not performed by the malfunctioning nozzle, and thus image quality is degraded. A conventional method of compensating for the image quality degradation due to the malfunctioning nozzle is described in U.S. Pat. No. 5,581,284. FIGS. 2A through 2D correspond to drawings illustrated in FIGS. 3 through 6 of U.S. Pat. No. 5,581,284.

The conventional method of compensating for a malfunctioning nozzle in a line printing type inkjet image forming apparatus is applied to a nozzle that does not eject ink properly or a nozzle that does not eject ink at all. When a malfunctioning nozzle for ejecting black ink is identified, ink droplets of other colors (i.e., cyan, magenta, and yellow) are sequentially ejected to a region 63 to which the malfunctioning nozzle should have ejected the black ink. These processes are illustrated in FIGS. 2B, 2C, and 2D. As described above, black color can be represented by printing the cyan, magenta, and yellow ink droplets on the same location of the print medium (i.e., the region 63), and a resulting black is called process black or composite black. However, this method is useful to compensate for a malfunction of a nozzle that ejects black ink, but it is not possible to compensate for a malfunction of nozzles that eject other color inks. In other words, since the nozzles for the cyan, magenta, and yellow ink do not operate when only the black color is printed, the process black can be formed using the nozzles that eject the cyan, magenta, and yellow ink. However, when a color image is printed (i.e., when the nozzles for the cyan, magenta, and yellow ink operate), the compensation cannot be performed using this conventional method due to the fact that the color ink nozzles are operating to print their respective colors. Further, when one of the nozzles used for compensation malfunctions, other colors such as red (yellow+magenta), green (cyan+yellow), or blue (cyan+magenta) color are printed, and thus printing quality is deteriorated.

According to the above-described conventional method and image forming apparatus, the printing defect caused by a malfunctioning nozzle may negatively affect the high-quality and high-speed printing of the image forming apparatus. Hence, there is a need to be able to compensate for malfunctioning nozzles to improve the image quality.

### SUMMARY OF THE INVENTION

The present general inventive concept provides an inkjet image forming apparatus and a method of compensating for a malfunctioning nozzle to enhance printing quality.

The present general inventive concept also provides an inkjet image forming apparatus and a method of compensating for a malfunctioning nozzle which can minimize effects of malfunctioning nozzles on printing quality.

The present general inventive concept also provides an inkjet image forming apparatus and a method of compensating for a malfunctioning nozzle that increases a lifespan of an inkjet printhead unit in the inkjet image forming apparatus.

The present general inventive concept also provides an inkjet image forming apparatus and a method of compensating for a malfunctioning nozzle to effectively compensate for image degradation due to malfunctioning nozzles based on a type of print media being used for printing.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing a printhead including a nozzle unit having a nozzle array to eject ink on a print medium to print an image and having a length that corresponds to a width of the print medium, and a compensating nozzle unit having a compensating nozzle array to eject a compensating solution on the print medium to compensate the image by diffusing the ink ejected from the nozzle unit and being installed parallel to the nozzle array in a direction that is perpendicular to a transferring direction of the print medium, wherein each nozzle disposed in the compensating nozzle array is positioned at a predetermined position between nozzles disposed in the nozzle array.

The position of each of the nozzles disposed in the compensating nozzle array may be in a range of ¼ to ¾ of a gap between two adjacent nozzles disposed in the nozzle array.

The position of each of the nozzles disposed in the compensating nozzle array may be substantially at a center of a gap between two adjacent nozzles disposed in the nozzle array.

Diameters of the nozzles in the compensating nozzle array may be greater than or equal to diameters of nozzles in the nozzle array, and less than or equal to twice the diameters of nozzles in the nozzle array.

Each of the nozzles disposed in the compensating nozzle array may have an elliptical shape.

The printhead may further include a plurality of head chips in which the nozzle unit and the compensating nozzle unit are formed to be longitudinally arranged in zigzag.

The nozzle unit may include a first nozzle array and a second nozzle array longitudinally arranged parallel to each other and to eject the same color ink, and nozzles disposed in the first nozzle array and the second nozzle array may be arranged to overlap with respect to each other along the transferring direction of the print medium.

The compensating nozzle unit may include a first compensating nozzle array and a second compensating nozzle array longitudinally arranged parallel to each other and to eject the compensating solution, and nozzles disposed in the first compensating nozzle array and the second compensating nozzle array may be arranged to overlap with respect to each other along the transferring direction of the print medium.

The foregoing and/or other aspects of the present general inventive concept may also be achieved by providing a printhead, including a single substrate, a nozzle unit formed on the substrate having nozzles and ink chambers containing ink to eject through the nozzles, and a compensating nozzle unit formed on the substrate and having compensating nozzles and compensating solution chambers containing compensating solution to eject through the compensating nozzles.

The printhead may further include an ink passage formed on the substrate and connected to the ink chambers, and a compensating solution passage formed on the substrate and connected to the compensating solution chambers. The ink passage may be parallel to the compensating solution passage. The nozzles may be arranged in first and second direction lines, and the compensating nozzles may be arranged in a line between the adjacent second direction lines. The compensating nozzle unit may eject the compensating solution before or after the nozzle unit ejects ink. The compensating nozzle unit may eject the compensating solution according to a detection of a malfunctioning nozzle which is one of the nozzles of the nozzle unit. The compensating nozzle unit may eject the compensating solution through at least two of the compensating nozzles when one of the nozzles of the nozzle unit malfunctions.

The foregoing and/or other aspects of the present general inventive concept may also be achieved by providing a printhead, including at least one nozzle unit extending along a lengthwise direction of the printhead and having nozzles to eject ink, and at least one compensating nozzle unit extending along the lengthwise direction of the printhead and having compensating nozzles to eject compensating solution to diffuse the ink, the compensating nozzles being alternatingly arranged with respect to the nozzles.

The foregoing and/or other aspects of the present general inventive concept may also be achieved by providing an inkjet image forming apparatus, including a printhead having a nozzle unit having a nozzle array to eject ink on a print medium to print an image and a length that corresponds to a width of the print medium, and a compensating nozzle unit having a compensating nozzle array to eject a compensating solution on the print medium to compensate the image by diffusing the ink ejected from the nozzle unit and being installed parallel to the nozzle array in a direction perpendicular to a transferring direction of the print medium. Each nozzle disposed in the compensating nozzle array is positioned at a predetermined position between nozzles disposed in the nozzle array.

The foregoing and/or other aspects of the present general inventive concept may also be achieved by providing an inkjet image forming apparatus including a nozzle unit having a nozzle array to eject ink on a print medium to print an image and having a length that corresponds to a width of the print medium, a compensating nozzle unit having a compensating nozzle array to eject a compensating solution on the print medium to compensate the image by diffusing the ink ejected from the nozzle unit and being installed parallel to the nozzle array in a direction that is perpendicular to a transferring direction of the print medium, a printhead having the nozzle unit and the compensating nozzle unit mounted thereon such that each nozzle disposed in the compensating nozzle array is positioned at a predetermined position between nozzles disposed in the nozzle array, a malfunctioning nozzle detecting unit to detect whether a malfunctioning nozzle exists in the nozzle unit, and a control unit to drive the nozzles in the compensating nozzle unit when the malfunctioning nozzle is detected such that the ink ejected from nozzles adjacent to the malfunctioning nozzle diffuses toward the compensating solution ejected from the compensating nozzle unit, thereby compensating for the malfunctioning nozzle.

The inkjet forming apparatus may further include a print medium detecting unit to detect a type of the print medium and to provide information about the type of the print medium to the control unit such that the control unit determines a compensation operation for a malfunctioning nozzle according to the detected type of the print medium.

The inkjet forming apparatus may further include a print medium confirming unit to confirm the type of the print medium and to provide information about the confirmed type of the print medium to the control unit such that the control unit determines a compensation operation for a malfunctioning nozzle according to the confirmed type of the print medium.

The foregoing and/or other aspects of the present general inventive concept may also be achieved by providing an image forming apparatus, including a printhead having a plurality of nozzles and a plurality of compensating nozzles, a print medium type unit to determine a type of print medium being used, a printing environment information unit to receive printing environment variables including a print mode, a malfunctioning nozzle detection unit to detect a malfunctioning nozzle of the printhead, and a control unit to select a compensation operation from among a plurality of compensation operations based on the detected type of the print medium and the print mode, and to operate the printhead accordingly.

The foregoing and/or other aspects of the present general inventive concept may also be achieved by providing an image forming apparatus, including a printhead to print to a print medium, the printhead including a first plurality of nozzles to eject ink to a plurality of first portions of the print medium and a second plurality of nozzles to eject compensating solution to a plurality of second portions of the print medium, and a control unit to control the printhead according to one or more printing environmental variables.

The foregoing and/or other aspects of the present general inventive concept may also be achieved by providing a method of compensating for a malfunctioning nozzle of an inkjet image forming apparatus which includes a printhead with a nozzle unit having a nozzle array with a length that corresponds to a width of the print medium and a compensating nozzle unit having a compensating nozzle array to eject a compensating solution on the print medium so as to diffuse ink ejected from the nozzle unit, the method including confirming a type of the print medium for printing, detecting whether a malfunctioning nozzle exists in the nozzle unit using a malfunctioning nozzle detecting unit, determining a compensation operation for the malfunctioning nozzle according to the confirmed type of the print medium when the malfunctioning nozzle exists, and compensating for the malfunctioning nozzle by driving nozzles in the compensating nozzle unit such that the ink ejected from nozzles adjacent to the malfunctioning nozzle diffuses toward the compensating solution ejected from the compensating nozzle unit according to the confirmed type of the print medium.

The confirming of the type of the print medium may include detecting the type of the print medium using a detecting unit having a light-emitting sensor and a light-receiving sensor.

The confirming of the type of the print medium may include receiving a confirming command via a user interface to confirm the type of the print medium.

The foregoing and/or other aspects of the present general inventive concept may also be achieved by providing a method of compensating for a malfunctioning nozzle in an image forming apparatus having a printhead with a plurality of nozzles and a plurality of compensating nozzles, a print medium type unit to determine a type of print medium between at least a first type and a second type, a malfunctioning nozzle detection unit to detect a malfunctioning nozzle of the printhead, the method including selecting a first compensation operation of the compensating nozzles when the first type of the print medium is detected and the malfunctioning nozzle is detected, selecting a second compensation operation of the compensating nozzles when the second type of the print medium is detected and the malfunctioning nozzle is detected, and driving the printhead according to the selected compensation operation.

The foregoing and/or other aspects of the present general inventive concept may also be achieved by providing a method of forming an image in an image forming apparatus having a printhead with a first plurality of nozzles that eject ink and a second plurality of nozzles that eject compensating solution, the method including ejecting ink to a plurality of first portions of the print medium via selected ones of the first plurality of nozzles, and ejecting compensating solution to one or more second portions of the print medium via a selected one or more of the second nozzles when the first plurality of nozzles includes a malfunctioning nozzle.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 illustrates printing patterns that are formed when a nozzle unit of a conventional line printing type inkjet image forming apparatus malfunctions;

FIGS. 2A through 2D are pixel images used to explain a conventional method of compensating for a malfunctioning nozzle of an inkjet image forming apparatus;

FIG. 3 is a schematic cross-sectional view illustrating an inkjet image forming apparatus according to an embodiment of the present general inventive concept;

FIG. 4 illustrates a printhead unit of the image forming apparatus of FIG. 3, according to an embodiment of the present general inventive concept;

FIG. 5 illustrates a driving mechanism of the printhead of FIG. 4, according to an embodiment of the present general inventive concept;

FIG. 6 is a partially enlarged view illustrating the printhead of FIG. 4, according to an embodiment of the present general inventive concept;

FIG. 7 illustrates a partially enlarged view of the printhead unit of FIG. 4, according to another embodiment of the present general inventive concept;

FIG. 8 illustrates a partially enlarged view of the printhead of FIG. 4, according to another embodiment of the present general inventive concept;

FIG. 9 illustrates the printhead of FIG. 3, according to another embodiment of the present general inventive concept;

FIG. 10 is a block diagram illustrating an image forming system according to an embodiment of the present general inventive concept;

FIG. 11 is a block diagram illustrating operation of the image forming system of FIG. 11, according to an embodiment of the present general inventive concept;

FIG. 12A illustrates a pattern that is formed when compensating ink is deposited on around areas where a malfunctioning nozzle fails to print;

FIG. 12B illustrates a compensation for a malfunctioning nozzle through diffusion of compensating solution and the compensating ink;

FIG. 13 illustrates changes in dot sizes when the same amount of ink droplet is deposited on different print media;

FIG. 14 illustrates print patterns according to different types of print media when a missing dot is generated;

FIG. 15 is a flow chart illustrating a method of compensating for a malfunctioning nozzle according to an embodiment of the present general inventive concept;

FIG. 16A illustrates a printing pattern formed when a malfunctioning nozzle is compensated and plain paper is used for printing;

FIG. 16B illustrates a printing pattern formed when a malfunctioning nozzle is compensated and photo paper or coated paper is used for printing; and

FIG. 16C illustrates a printing pattern formed when a malfunctioning nozzle is compensated and a transparent film is used for printing.

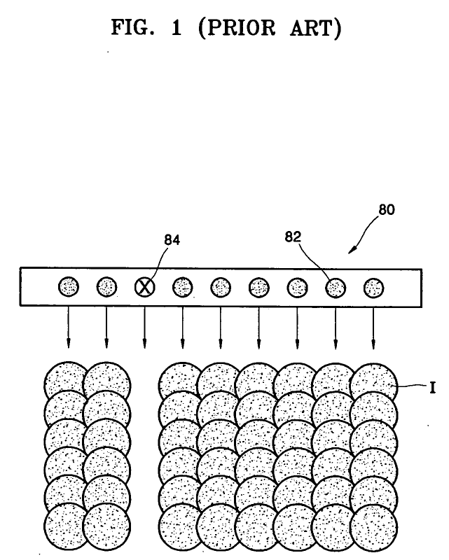

### DETAILED DESCRIPTION OF THE PREFERRED EMBODIMENTS

An inkjet image forming apparatus including a printhead and a method of compensating for a malfunctioning nozzle will now be described more fully with reference to the accompanying drawings, in which exemplary embodiments of the general inventive concept are illustrated. For explanation purposes, a structure of the inkjet image forming apparatus will be described, and then the method of compensating for the malfunctioning nozzle will be described. In the drawings, the thicknesses of lines and sizes are exaggerated for clarity, and like reference numerals refer to the like elements throughout. The embodiments are described below in order to explain the present general inventive concept by referring to the figures.

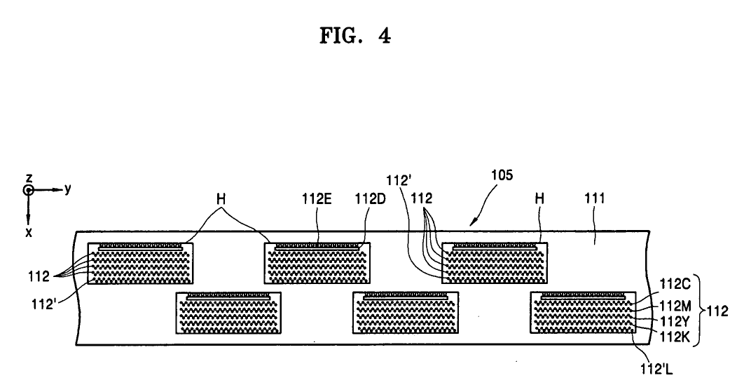

FIG. 3 is a cross-sectional view illustrating an inkjet image forming apparatus 125 according to an embodiment of the present general inventive concept.

Referring to FIG. 3, the inkjet image forming apparatus 125 includes a feeding cassette 120, a printhead unit 105, a supporting member 114 opposite to the printhead unit 105, a malfunctioning nozzle detecting unit 132 to detect a malfunctioning nozzle, a print medium transferring unit 500 to transfer a print medium P in a first direction (i.e., an x direction), and a stacking unit 140 on which the discharged print medium P is stacked. In addition, the inkjet image forming apparatus 125 further includes a control unit 130 to control each component thereof. The printhead unit 105 includes a body 110 disposed in a carriage 106, and a printhead 111 having a nozzle unit 112 disposed on the body 110. The image forming apparatus 125 may include a print medium detecting unit 122 to detect a type of print medium disposed in the feeding cassette 120 and/or to detect whether there is printing medium P stacked in the feeding cassette 120. The print medium detecting unit 122 may be a print medium confirming unit.

The print medium P is stacked on the feeding cassette 120. The print medium P is transferred from the feeding cassette 120 under the printhead 111 to the stacking unit 140 by the print medium transferring unit 500.

The print medium transferring unit 500 transfers the print medium P along a predetermined path and includes a pick-up roller 117, an auxiliary roller 116, a feeding roller 115, and a discharging roller 113. The print medium transferring unit 500 is driven by a driving source 131, such as a motor, and provides a transferring force to transfer the print medium P. The driving source 131 is controlled by the control unit 130. That is, the control unit 130 controls the operation of the driving source 131 to set a speed of the print medium P.

The pick-up roller 117 is installed at one side of the feeding cassette 120 and picks up the print medium P stacked in the feeding cassette 120. The feeding roller 115 is installed at an inlet side of the printhead 111 and feeds the print medium P drawn out by the pick-up roller 117 to the printhead 111. The feeding roller 115 includes a driving roller 115A to supply the transferring force to transfer the print medium P, and an idle roller 115B elastically engaged with the driving roller 115A. The auxiliary roller 116 that transfers the print medium P may be further installed between the pick-up roller 117 and the feeding roller 115. The discharging roller 113 is installed at an outlet side of the printhead 111 and discharges the print medium P on which the printing has been completed out of the image forming apparatus 125. The discharged print medium P is stacked on the stacking unit 140.

The discharging roller 113 includes a star wheel 113A installed along a width direction of the print medium P (i.e., a y-direction), and a supporting roller 113B opposite to the star wheel 113A to support a rear side of the print medium P. The print medium P may wrinkle due to ink ejected onto a top side of the print medium P while the print medium P passes under the nozzle unit 112. A distance between the print medium P and the nozzle unit 112 may not be maintained due to the wrinkles of the print medium P. The star wheel 113A prevents the print medium P fed under the nozzle unit 112 from contacting a bottom surface of the nozzle unit 112 or the body 110, or prevents the distance between the print medium P and the bottom surface of the nozzle unit 112 or the body 110 from being changed. The star wheel 113A is installed such that at least a portion of the star wheel 113A protrudes from the nozzle unit 112, and contacts at a point of a top surface of the print medium P.

The supporting member 114 is installed below the printhead 111 and supports the rear side of the print medium P to maintain a predetermined distance between the nozzle unit 112 and the print medium P. The distance between the nozzle unit 112 and the print medium P may be about 0.5-2.5 mm.

The malfunctioning nozzle detecting unit 132 detects a malfunctioning nozzle, which can be generated in a manufacturing process or during a printing operation. The malfunctioning nozzle is a nozzle that does not eject ink properly or a nozzle that does not eject ink at all. That is, the malfunctioning nozzle exists when ink is not ejected from nozzles due to several causes, or when a smaller amount of ink droplets is ejected. The malfunctioning nozzle is generated in a process of manufacturing the printhead 111 or during the printing operation. In general, information about the malfunctioning nozzle generated in the manufacturing process is stored in a memory (not illustrated) installed in the printhead 111. The information can be transmitted to the image forming apparatus 125 when the printhead 111 is mounted in the image forming apparatus 125.

In general, a printhead of an inkjet image forming apparatus can be classified according to an actuator that provides an ejecting force to ink droplets. When ink is ejected using thermal driving, a case in which a malfunctioning nozzle is caused by (1) a heater used for ejecting ink being disconnected, (2) a driving circuit of the heater is broken, or (3) damage of an electrical element such as a field emission transistor (FET), and the like can be easily detected. Likewise, when ink is ejected using piezoelectric driving, defects of a piezoelectric device or malfunctions of nozzles that are caused by damages of a driving circuit for driving the piezoelectric device can be easily detected.

On the other hand, a malfunctioning nozzle that is clogged with foreign matters may not be easily detected. When the causes of a malfunctioning nozzle cannot be easily detected, test page printing is performed. If a malfunctioning nozzle exists in the nozzle unit 112, a print concentration of a portion of the print medium P printed by the malfunctioning nozzle is lower than a portion of the print medium P printed by a normal nozzle (i.e., a functioning nozzle) due to missing dots caused by the malfunctioning nozzle.

The portion printed with the lower print concentration can be detected by the malfunctioning nozzle detecting unit 132, such as an optical sensor (not illustrated). In this manner, a nozzle that malfunctions can be detected.

The malfunctioning nozzle detecting unit 132 may include a first malfunctioning nozzle detecting unit 132A and a second malfunctioning nozzle detecting unit 132B. The first malfunctioning nozzle detecting unit 132A detects whether nozzles are clogged by radiating light directly onto the nozzle unit 112, and the second malfunctioning nozzle detecting unit 132B detects whether a malfunctioning nozzle exists in the nozzle unit 112 by radiating light onto the print medium P when the print medium P is transferred, and converting the reflected light into electric signals.

Additionally, a nozzle inspection signal may be transmitted to each nozzle in the printhead 111, and thus whether a malfunctioning nozzle exists can be detected according to a response to the nozzle inspection signal. A method of detecting a malfunctioning nozzle is known to those of skill in the art, and thus a detailed description thereof will not be provided. Other various apparatuses and methods can be used to detect a malfunctioning nozzle.

In the present embodiment, the malfunctioning nozzle detecting unit 132 includes the optical sensor. The optical sensor includes a light-emitting sensor, such as a light emitting diode that radiates light onto the print medium P and a light-receiving sensor that receives light reflected from the print medium P. An output signal from the light-receiving sensor is provided to the second malfunctioning nozzle detecting unit 132B. The second malfunctioning nozzle detecting unit 132B detects whether a malfunctioning nozzle exists in the nozzle unit 112 in response to the output signal, and information about whether the malfunctioning nozzle exists in the nozzle unit 112 is stored in a memory (not illustrated) and is transmitted to the control unit 130. The light-emitting sensor and the light-receiving sensor can be integrally formed as one body or can be formed as separate units. The structures and functions of the optical sensor are known to those of skill in the art, and thus a detailed description thereof will not be provided.

The malfunctioning nozzle detecting unit 132 detects whether the malfunctioning nozzle exists in the nozzle unit 112 using the above-described operations and/or processes. Information about the malfunctioning nozzle detected by the malfunctioning nozzle detecting unit 132 is stored in the memory, and the control unit 130 controls the operation of each component of the image forming apparatus 125 according to the information about the malfunctioning nozzle stored in the memory.

The printhead unit 105 prints an image by ejecting ink onto the print medium P, and includes the body 110, the printhead 111 installed at one side of the body 110, the nozzle unit 112 formed on the printhead 111, and the carriage 106 on which the body 110 is mounted. The body 110 is mounted in the carriage 106 in a cartridge type manner. The feeding roller 115 is rotatably installed at the inlet side of the nozzle unit 112, and the discharging roller 113 is rotatably installed at the outlet side of the nozzle unit 112.

Although not illustrated, a removable cartridge type ink container is provided in the body 110. Further, the body 110 may include chambers, each of which has an ejecting unit (for example, piezoelectric elements or heat-driving typed heaters that are connected to respective nozzles of the nozzle unit 112 and provide pressure to eject the ink), a passage (for example, an orifice) to supply the ink contained in the body 110 to each chamber, a manifold that is a common passage to supply the ink that flows through the passage to the chamber, and a restrictor that is an individual passage to supply the ink from the manifold to each chamber. The chamber, the ejecting unit, the passage, the manifold, and the restrictor are known to those skilled in the art, and thus detailed descriptions thereof will not be provided. In addition, the ink container (not illustrated) may be separately installed from the printhead unit 105. The ink stored in the ink container may be supplied to the printhead unit 105 through a supplying unit similar to a hose.

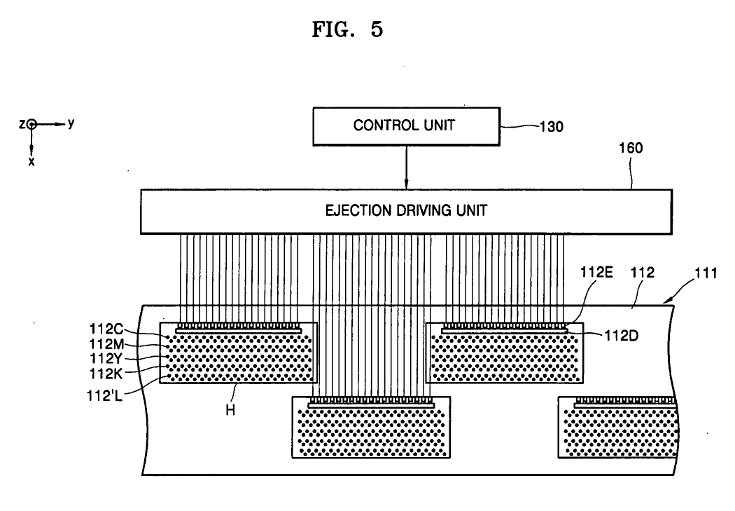

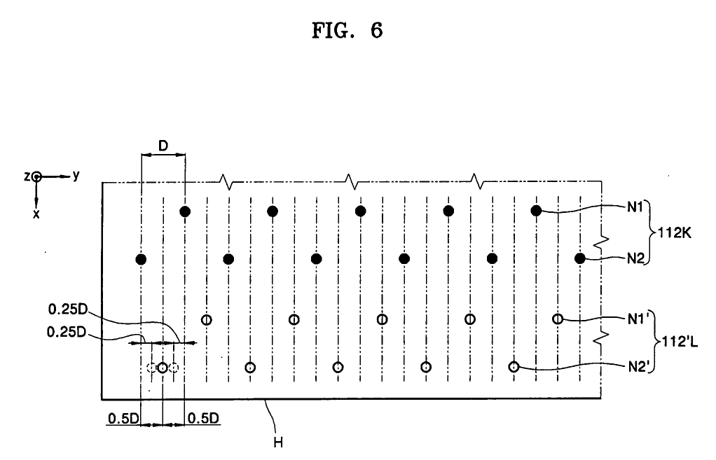

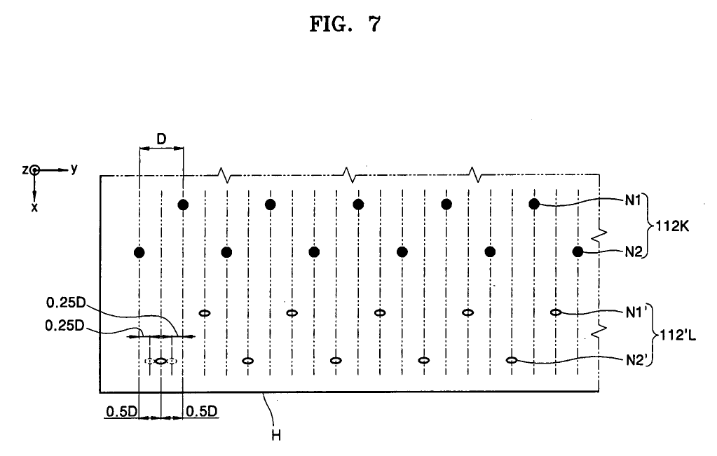

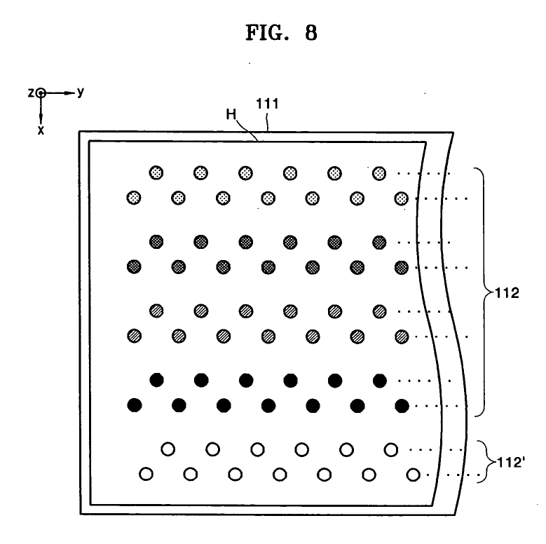

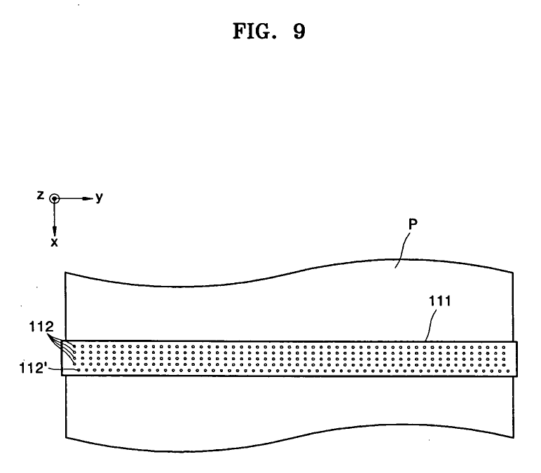

FIG. 4 illustrates the printhead unit 105 of FIG. 3, according to an embodiment of the present general inventive concept. FIG. 5 illustrates a driving mechanism of the printhead 111 of FIG. 4, according to an embodiment of the present general inventive concept. FIG. 6 is a partially enlarged view of the printhead 111 of FIG. 4, according to an embodiment of the present general inventive concept. FIG. 7 illustrates a partially enlarged view of the printhead 111 of FIG. 3, according to another embodiment of the present general inventive concept. FIG. 8 illustrates a partially enlarged view of the printhead 111 of FIG. 3, according to another embodiment of the present general inventive concept. FIG. 9 illustrates the printhead 111 of FIG. 3, according to another embodiment of the present general inventive concept.

Referring to FIGS. 3 and 4, the printhead 111 is installed along the second direction (i.e., the y direction) with respect to the print medium P that is transferred along the first direction (i.e., the x direction). The printhead 111 uses heat energy or a piezoelectric device as an ink ejecting mechanism, and is made to have a high resolution using a semiconductor manufacturing process including, for example, etching, deposition, or sputtering. The printhead 111 includes the nozzle unit 112 to eject ink onto the print medium P to form an image and a compensating nozzle unit 112′ to eject compensating solution onto the print medium P to compensate for a malfunctioning nozzle. The compensating solution may be a solution to diffuse ink ejected from the nozzle unit 112, and may be a solvent included in the ink. The printhead 111 includes a plurality of nozzle units 112 and a plurality of compensating nozzle units 112′, and each nozzle unit 112 and each compensating nozzle unit 112′ form a unit (or an array), as illustrated in FIG. 4. The nozzle units 112 may have a length that is greater than or equal to a width of the print medium. The compensating nozzle unit 112′ ejects ink onto a first position adjacent to a second position where ink has been ejected from the nozzle unit 112 so as to compensate the image using diffusion of the ink ejected from the nozzle unit 112. The nozzle unit 112 ejects ink, and the compensating nozzle unit 112′ ejects compensating solution. In other words, the ink ejected from the nozzle unit 112 is diffused via the compensating solution. The compensating solution may be transparent ink or a catalyzer with which ink is properly diffused. The compensating nozzle unit 112′ includes a compensating nozzle array 112′L, which is parallel to other nozzle arrays (e.g., 112C, 112M, 112Y, and 112K) of the nozzle unit 112 along the second direction (i.e., the y-direction), and the compensating nozzle array 112′L is spaced apart from the other nozzle arrays of the nozzle unit 112 in the transferring direction of the print medium P. Nozzles of each nozzle array (112C, 112M, 112Y, and 112K) are arranged in the second direction, and nozzles of each compensating nozzle unit 112′ are arranged in the second direction. Each nozzle in the compensating nozzle unit 112′ may be disposed between the nozzles of the nozzle unit 112 so as to properly diffuse ink such that the nozzles of the compensating nozzle unit 112′ can eject the compensating solution between positions to which the adjacent nozzles of the nozzle unit 112 eject ink. The compensating nozzle units 112′ may also have a length that is greater than or equal to the width of the print medium P.

Referring to FIGS. 3 to 5, an ejection driving unit 160 provides an ejecting force to ink droplets, drives the printhead 111 at a predetermined frequency to print the image on the print medium P. The ejection driving unit 160 can be classified according to an actuator that provides the ejecting force to the ink droplets. A first type is a thermal driving printhead that generates bubbles in ink using a heater, thereby ejecting the ink droplets due to an expanding force of the bubbles. The second type is a piezoelectric driving printhead that ejects the ink droplets using a pressure applied to ink due to deformation of a piezoelectric device. The ejection driving unit 160 that drives the nozzles in the nozzle unit 112 is controlled by the control unit 130.

As described above, the printhead 111 includes the nozzle unit 112 to print the image and the compensating nozzle unit 112′ to compensate the image for a malfunctioning nozzle. The nozzle unit 112 and the compensating nozzle unit 112′ may be mounted in the printhead 111 as a head chip H type, or a line type.

The nozzle unit 112 ejects ink of at least one color onto the print medium P to print the image. The nozzle array that ejects ink of the same color may be arranged in a single longitudinal line, or in two lines that overlap with respect to each other along the x-direction (i.e., the paper transferring direction). Hereinafter, the printhead 111 having various shapes will be described.

For explanation purposes, the structures and arrangements of the nozzle unit 112 and the compensating nozzle unit 112′ according to an embodiment of the present general inventive concept will be described with reference to FIGS. 4 and 6.

Referring to FIG. 4, a plurality of head chips H having the plurality of nozzle arrays 112C, 112M, 112Y, and 112K and the compensating nozzle array 112′L may be formed in the printhead 111. Each of the head chips H has a driving circuit 112D which time-divisionally drives nozzles selectively or in units of a group of nozzles. When the plurality of head chips H are arranged in a single line, a distance between the head chips H may become greater than a distance between the nozzles in the same head chips H, thereby generating an unprinted portion. Therefore, the plurality of head chips H may be arranged in a zigzag shape in the second direction (i.e., the y direction).

The nozzle array among the nozzle arrays 112C, 112M, 112Y, and 112K in each of the head chips H which ejects ink of the same color may be disposed to overlap with one another along the x-direction to enhance a printing resolution in the second direction (i.e., the y direction). In this case, ink dots (i.e., droplets) ejected by nozzles in a first nozzle array N1 are deposited on positions between ink dots ejected by nozzles in a second nozzle array N2, thereby enhancing the printing resolution in the second direction (i.e., the y direction). That is, the first nozzle array N1 and the second nozzle array N2 are arranged parallel to each other along the second direction and eject ink of the same color. The nozzles in the first nozzle array N1 and the second nozzle array N2 may overlap with each other.

When a malfunctioning nozzle in the nozzle unit 112 is detected by the malfunctioning nozzle detecting unit 132, the compensating nozzle unit 112′ compensates for the malfunctioning nozzle by ejecting the compensating solution from nozzle(s) in the compensating nozzle array 112′L that is adjacent to the malfunctioning nozzle. Here, the ink ejected from the nozzle unit 112 onto the print medium P is diffused toward a position where the compensating solution is ejected from the compensating nozzle unit 112′, and thus a missing dot that results from the malfunctioning nozzle can be compensated for by the diffusion. Due to the diffusion of the ink, the compensating solution ejected onto the print medium P has the same color as the adjacent ink droplet. In addition, the compensating nozzle unit 112′ may include a first compensating nozzle array N1′ and a second compensating nozzle array N2′ arranged in parallel to each other in the second direction (x-direction), and nozzles disposed in the first compensating nozzle array N1′ and the second compensating nozzle array N2′ may be arranged to overlap with each other. It should be understood that the compensating solution can be ejected from the compensating nozzle unit 112′ before or after the ink is ejected from the adjacent nozzles in the nozzle unit 112. Additionally, the compensating nozzle unit 112′ may be arranged on either side of the nozzle unit 112 along the x-direction.

As described above, the compensating nozzle unit 112′ compensates for malfunctioning nozzles using the diffusion effect of ink ejected from the nozzles adjacent to the malfunctioning nozzle. As illustrated in FIG. 6, each of the nozzles of the compensating nozzle unit 112′ is respectively positioned at a predetermined position between two adjacent nozzles of the nozzle unit 112 so as to effectively use the diffusion effect of ink. Here, the position of each of the nozzles disposed in the first and second compensating nozzle arrays N1′ and N2′ of the compensating nozzle unit 112′ may be substantially at a center or in a range of ¼ to ¾ of a gap between two adjacent nozzles disposed in the first and second nozzle arrays N1 and N2 of the nozzle unit 112 so as to minimize a visible printing defect caused by missing dots due to the malfunctioning nozzles. The nozzles of the compensating nozzle unit 112′ can be staggered between the nozzles of the nozzle unit 112 along the y-direction.

Diameters of the nozzles disposed in the first and second compensating nozzle arrays N1′ and N2′ of the compensating nozzle unit 112′ may be greater than or equal to diameters of the nozzles disposed in the first and second nozzle arrays N1 and N2 of the nozzle unit 112, in order to effectively compensate for the malfunctioning nozzle using the above described diffusion effects. When a malfunctioning nozzle is compensated for, a compensating solution droplet and an adjacent ink droplet are effectively mixed. However, when a size of the compensating solution droplet ejected by the compensating nozzle unit 112′ is too large, the compensating solution droplet may be undesirably mixed with the ink droplets ejected on the other portions of the print medium P (i.e., not only the adjacent ink droplet), thereby significantly degrading the printing quality. Accordingly, the diameters of the nozzles in the compensating nozzle unit 112′ may be less than or equal to twice the diameters of the nozzles in the nozzle unit 112. In another embodiment of the present general inventive concept, as illustrated in FIG. 5, the sizes of the compensating solution droplets can be controlled by controlling the operation of the ejection driving unit 160. For example, the control unit 130 can control the sizes of the compensating solution droplets ejected by the nozzles in the compensating nozzle unit 112′ by adjusting a heating temperature of a heater or a driving timing of a piezoelectric device. The control unit 130 may control the size of the compensating solution droplets ejected by the nozzles in the compensating nozzle unit 112′ to be greater than the size of the ink droplets ejected by the nozzles in the nozzle unit 112 and less than or equal to twice the size of the ink droplets ejected by the nozzles in the nozzle unit 112.

As described above, the compensating nozzle unit 112′ should be designed not to undesirably mix the compensating solution droplets ejected from the compensating nozzle unit 112′ with the ink droplets ejected on the other portions of the print medium P. In an embodiment of the present general inventive concept, as illustrated in FIG. 7, each of the nozzles disposed in the compensating nozzle unit 112′ may have an elliptical shape having a horizontal long radius.

Although the printhead 111 having the head chips H including the nozzle unit 112 and the compensating nozzle unit 112′ is described in the present embodiment as having an arrangement illustrated in FIGS. 4 through 7, the printhead 111 may alternatively have a variety of other shapes and/or arrangements. For example, the printhead 111 may be formed of a single head chip having a length that is equal to the length of the printhead 111 (i.e., the width of the print medium P). As illustrated in FIG. 8, the nozzles of the nozzle unit 112 are arranged in the respective lines in the transferring direction, and the nozzles of the compensating nozzle unit 112′ are arranged in respective lines which are between the adjacent respective lines of the nozzles of the nozzle unit 112 in the transferring direction. Referring to FIG. 9, in the printhead 111, a nozzle array that corresponds to the width of the print medium P is arranged along the second direction.

Each of the nozzles in the nozzle unit 112 and the compensating nozzle unit 112′ includes the driving circuit 112D and a cable 112E to receive printing data, electric power, control signals, etc. The cable 112E may be a flexible printed circuit (FPC) or a flexible flat cable (FFC).

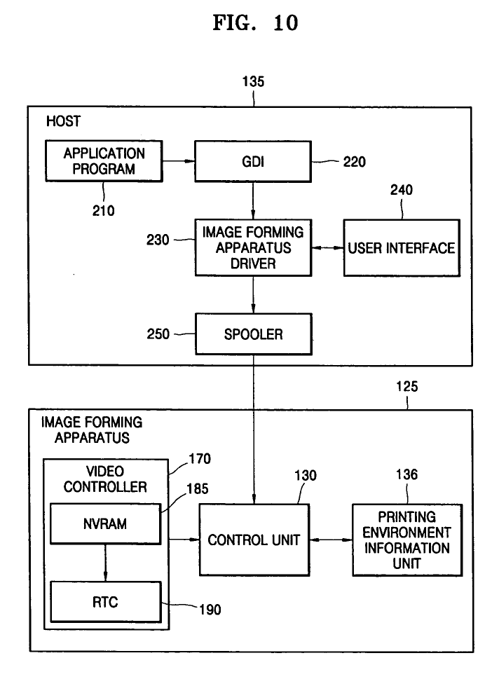

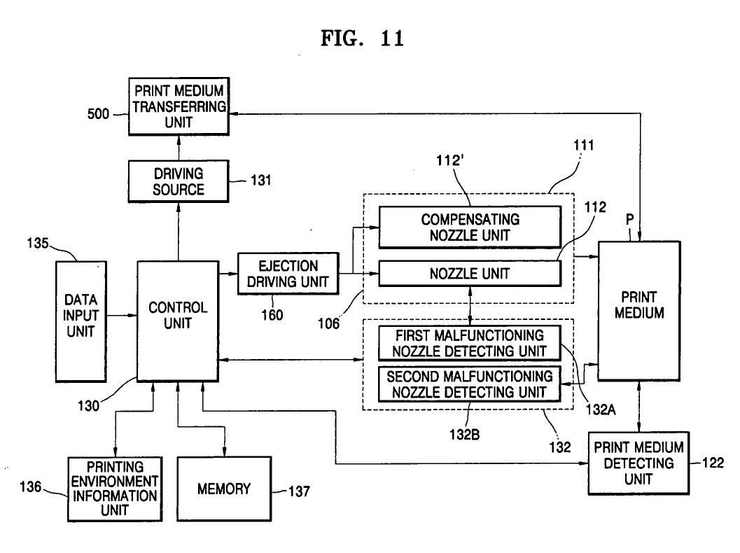

FIG. 10 is a block diagram illustrating an image forming system according to an embodiment of the present general inventive concept. FIG. 11 is a block diagram illustrating operation of the image forming system of FIG. 10, according to an embodiment of the present general inventive concept. The image forming system of FIGS. 10 and 11 may include the image forming apparatus 125 of FIG. 3. Accordingly, for illustration purposes, the image forming system of FIGS. 10 and 11 are described below with reference to FIGS. 3 to 9. The image forming system includes a data input unit 135 (i.e., a host system), and the inkjet image forming apparatus 125.

Referring to FIG. 10, the data input unit 135 is the host system such as a personal computer (PC), a digital camera, or a personal digital assistant (PDA) and receives image data to be printed. The data input unit 135 includes an application program 210, a graphics device interface (GDI) 220, an image forming apparatus driver 230, a user interface 240, and a spooler 250.

The application program 210 generates and edits an object that can be printed by the image forming apparatus 125. The GDI 220, which is a program installed in the host system, receives the object from the application program 210, sends the object to the image forming apparatus driver 230, and generates commands related to the object in response to a request from the image forming apparatus driver 230. The image forming apparatus driver 230 is a program installed in the host system to generate printer commands that can be interpreted by the image forming apparatus 125. The user interface 240 for the image forming apparatus driver 230 is a program installed in the host system and provides environment variables with which the image forming apparatus driver 230 generates the printer commands. A user can select a print mode, such as a draft mode, a normal mode, and a high-resolution mode, or a print medium, such as plain paper, photo paper, and a transparent film via the user interface 240. The user interface 240 may be a print medium confirming unit. The spooler 250 is a program installed in the operating system of the host system and transmits the printer commands generated by the image forming apparatus driver 230 to an input/output device (not illustrated) of the image forming apparatus 125.

The inkjet image forming apparatus 125 includes a video controller 170, the control unit 130, a printing environment information unit 136. The video controller 180 may include a non-volatile random access memory (NVRAM) 185, a static random access memory (SRAM, not illustrated), a synchronous dynamic random access memory (SDRAM, not illustrated), a NOR Flash (not illustrated), and a real time clock (RTC) 190. The video controller 180 interprets the printer commands generated by the image forming apparatus driver 230 to convert the printer commands into corresponding bitmaps and transmits the bitmaps to the control unit 130. The control unit 130 transmits the bitmaps to each component of the image forming apparatus 125 to print an image on the print medium P. Through above described processes, the image forming apparatus 125 prints the image.

Referring to FIGS. 10 and 11, the control unit 130 may be mounted on a motherboard (not illustrated) of the image forming apparatus 125, and controls an ejecting operation of the nozzle unit 112 and the compensating nozzle unit 112′ installed in the printhead 111, and a transferring operation of the print medium transferring unit 500 according to whether a malfunctioning nozzle exists (i.e., is detected by the malfunctioning nozzle detecting unit 132), the type of the print medium P, and/or the selected print mode. That is, the control unit 130 synchronizes the operation of each component of the image forming apparatus 125 so that the ink ejected from the nozzle unit 112 and the compensating solution ejected from compensating nozzle unit 112′ can be deposited on a desired area of the print medium P according to the detection of a malfunctioning nozzle by the malfunctioning nozzle detecting unit 132, or information about the type of the print medium P detected by the print medium detecting unit 122 or inputted through the user interface 240.

In addition, the control unit 130 stores the image data input through the data input unit 135 in a memory 137, and confirms whether the image data to be printed is completely stored in the memory 137.

The printing environment information unit 136 stores a plurality of printing environment information that corresponds to each type of printing environment set when the image data input from the application program 210 is printed. That is, the printing environment information unit 136 stores printing environment information that corresponds to each printing environment input from the user interface 240 when a print command/request is received. That is, the print command/request may be received with the print environment information. Here, the printing environment includes at least one of a printing density, a resolution, a size of the print medium P, a type of the print medium P, a temperature, humidity, and a continuous printing mode. The control unit 130 controls the operations of the ejection driving unit 160 or the driving source 131 according to each printing environment stored in the printing environment information unit 136 that corresponds to the input printing environment. For example, the printing environment information unit 136 stores printing environment information that corresponds to the type of the print medium P detected by the print medium detecting unit 122.

Hereinafter, the operation of compensating for a malfunctioning nozzle of the printhead 111 and the inkjet image forming apparatus 125 having the same will be described.

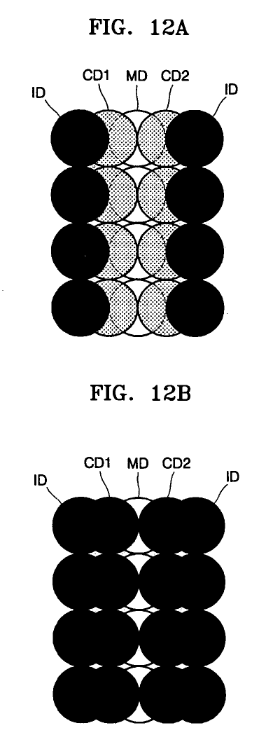

FIG. 12A illustrates a pattern that is formed when compensating ink is deposited on areas around where a malfunctioning nozzle prints (i.e., fails to print). FIG. 12B illustrates the compensation for a malfunctioning nozzle using the diffusion of the compensating solution.

Referring back to FIGS. 10 and 11, if a malfunctioning nozzle is not detected, the control unit 130 drives the nozzle unit 112 according to a time when the print medium P is transferred to the nozzle unit 112, thereby printing an image. The control unit 130 generates and outputs control signals to drive the ejection driving unit 160 to print the image on the print medium P, and the ejection driving unit 160 receives the control signals to drive the nozzle unit 112.

When a malfunctioning nozzle is detected, the information about the malfunctioning nozzle in the nozzle unit 112 is input into the malfunctioning nozzle detecting unit 132 and transmitted to the control unit 130. The detection of the malfunctioning nozzle by the malfunctioning nozzle detecting unit 132 is described above, and will not be described here. As illustrated in FIG. 12A, the control unit 130 drives the compensating nozzle unit 112′ such that a compensating solution droplet(s) CD is deposited on a position adjacent to a missing dot MD where ink is not ejected from the malfunctioning nozzle. That is, the control unit 130 drives a pair of nozzles in the compensating nozzle unit 112′, which are adjacent to the malfunctioning nozzle such that first and second compensating solution droplets CD1 and CD2 are deposited on positions adjacent to the missing dot MD. As illustrated in FIG. 12B, due to the first and second compensating solution droplets CD1 and CD2, an ink droplet(s) ID ejected from the nozzle unit 112 is diffused and thus colors of the first and second compensating solution droplets CD1 and CD2 become the same as that of the adjacent ink droplet(s) ID. Therefore, a white line that would result from the malfunctioning nozzle does not appear, since the adjacent ink droplet(s) ID is diffused and the color of the compensating solution becomes the same as that of the adjacent ink droplet(s). Accordingly, image degradation due to the malfunctioning nozzle can be prevented.

In the present embodiment, although the pair of nozzles in the compensating nozzle unit 112′ adjacent to the missing dot MD eject the first and second compensating solution droplets CD1 and CD2 to compensate for the malfunctioning nozzle, it should be understood that one or more compensating solution droplets may instead be ejected in order to compensate for the malfunctioning nozzle depending on the type of the print medium P.

In general, the sizes of the ink droplets and the compensating solution droplets deposited on the print medium P are varied according to the type of print medium P. That is, even when the same amount of ink droplets or compensating solution droplets are ejected, the sizes of the droplets deposited on the print medium P are varied according to the type of the print medium P. Accordingly, when a malfunctioning nozzle is compensated for, a compensation process that is used should be varied according to the type of the print medium P being used. Hereinafter, a method of compensating for a malfunctioning nozzle based on the type of the print medium P will be described.

Referring back to FIG. 3, the type of the print medium P is detected by the print medium detecting unit 122. The print medium detecting unit 122 includes a light-emitting sensor and light-receiving sensor installed above the feeding cassette 120 or along a transferring pathway of the print medium P. The print medium detecting unit 122 radiates light onto the print medium P and detects the type of the print medium P from the reflected light. Accordingly, the print medium detecting unit 122 detects the print medium P as plain paper, photo paper, coated paper, or a transparent film, such as over head project (OHP) film. A user can confirm the type of the print medium P using a print medium confirming unit (e.g., the user interface 240). That is, the print medium confirming unit may be the user interface 240, and the image forming apparatus driver 230 installed in the image forming apparatus 125 such that the user can select the type of the print medium P. In addition, various other apparatuses and methods can be used to confirm the type of the print medium P.

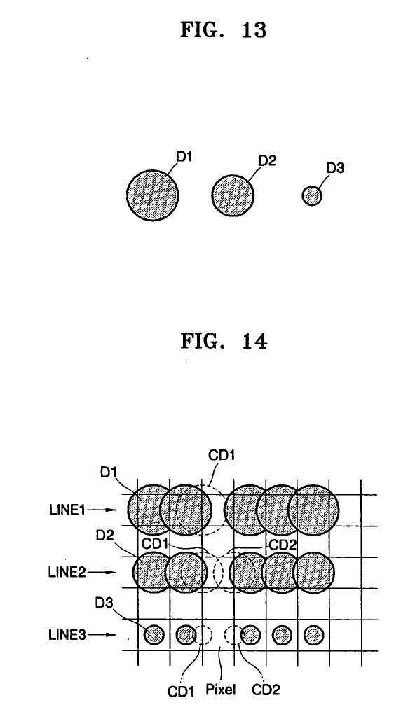

FIG. 13 illustrates changes in dot sizes when the same amount of ink droplets is deposited on different print media types. Referring to FIG. 13, even when the same amount of ink droplets is deposited on the print medium P, the dot sizes are varied according to the type of the print medium P. An ink droplet D1 that is deposited on the print medium P, such as plain paper easily spreads and the dot size is relatively large. An ink droplet D2 that is deposited on the print medium P, such as photo paper or coated paper spreads less and the dot size is smaller. Since a transparent film has a waterproof surface, an ink droplet D3 deposited thereon does not spread, and thus the dot size of the ink droplet D3 is the smallest. Therefore, although the same amount of the ink droplets is deposited on the print medium P, the dot sizes are varied according to the type of the print medium P.

FIG. 14 illustrates print patterns formed according to the types of print media when a missing dot is generated. Referring to FIG. 14, LINE 1 represents a print pattern formed when ink droplets D1 are deposited on plain paper, LINE 2 represents a print pattern formed when ink droplets D2 are deposited on photo paper, and LINE 3 represents a print pattern formed when ink droplets D3 are deposited on a transparent film. In addition, each quadrangle indicates a pixel where the ink droplets are deposited.

As illustrated in LINE 1 of FIG. 14, when printing onto plain paper, the dot size is large (i.e., approximately 100 μm), and a pixel unfilled because of a missing dot can not be easily seen or noticed. Moreover, since boundaries of the ink dots printed on the plain paper become unclear due to feathering, effects of the missing dot cannot be easily seen. Accordingly, when printing onto the plain paper, even if the compensating solution is ejected using one of nozzles in the compensating nozzle unit 112′ adjacent to the malfunctioning nozzle, the image degradation due to the malfunctioning nozzle cannot be easily seen. That is, when printing to the plain paper, the compensating solution is deposited on a relatively large area such that the adjacent ink dots can diffuse, and thus only a single compensating solution droplet CD1 may be used to compensate for the malfunctioning nozzle. Alternatively, since the missing dot cannot be easily seen, it may not be necessary to eject any droplets of the compensating solution to compensate for the malfunctioning nozzle on plain paper. For example, the single compensating solution droplet CD1 may be used when printing in a high resolution mode, while no droplets may be used when printing in a draft mode and a normal mode.

As illustrated in LINE 2 of FIG. 14, the ink droplets D2 deposited on photo paper or coated paper are smaller than the ink droplets D1 deposited on plain paper. The ink dots D2 deposited on the photo paper or the coated paper have a diameter of approximately 50 to 70 μm and a clear boundary. Accordingly, when a malfunctioning nozzle exists, the degradation due to the malfunctioning nozzle can be easily seen, and thus the malfunctioning nozzle should be compensated for. Since the sizes of the compensating solution droplets CD1 and CD2 deposited on the photo paper or the coated paper are small, a pair of the compensating nozzle arrays adjacent to the malfunctioning nozzle may be used for the compensation (i.e., by depositing more than one droplet CD1 and CD2 of compensating solution).

Furthermore, since, as illustrated in LINE 3 of FIG. 14, the ejected ink D3 does not penetrate a transparent film, such as an OHP film, the dot size is smallest (i.e., less than approximately 50 μm after drying) such that the missing dot can be easily seen. Accordingly, when the transparent film is used for printing, the sizes of the compensating solution droplets CD1 and CD2 ejected from the pair of the compensating nozzle arrays adjacent to the malfunctioning nozzle should be increased. That is, the control unit 130 may control the ejection driving unit 160 to increase the sizes of the compensating solution droplets CD1 and CD2. The method of ejecting the large sizes of the compensating solution droplets is known to those of skill in the art, and thus a detailed description thereof will not be provided here.

Hereinafter, a method of compensating for a malfunctioning nozzle according to an embodiment of the present general inventive concept will be described in conjunction with the operation of the control unit 130.

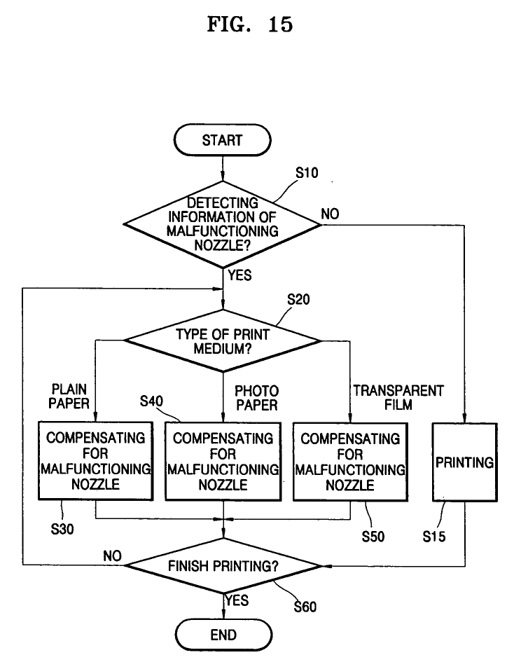

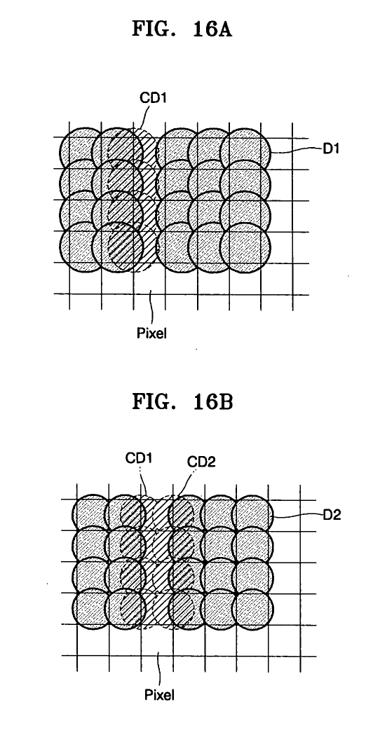

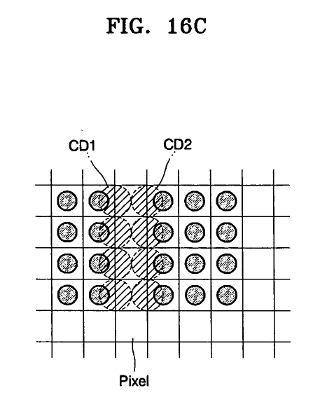

FIG. 15 is a flow chart of a method of compensating for a malfunctioning nozzle according to an embodiment of the present general inventive concept. The method of FIG. 15 may be performed in the image forming apparatus of FIGS. 3, 10, and 11. Accordingly, for illustration purposes, the method of FIG. 15 is described below with reference to FIGS. 3 to 14. FIG. 16A illustrates a printing pattern formed when a malfunctioning nozzle is compensated and plain paper is used. FIG. 16B illustrates a printing pattern formed when a malfunctioning nozzle is compensated for and photo paper or coated paper is used. FIG. 16C illustrates a printing pattern formed when a malfunctioning nozzle is compensated for and a transparent film is used. Shaded regions in FIG. 16A through 16C represent compensated regions with compensating solution droplets CD1 and CD2.

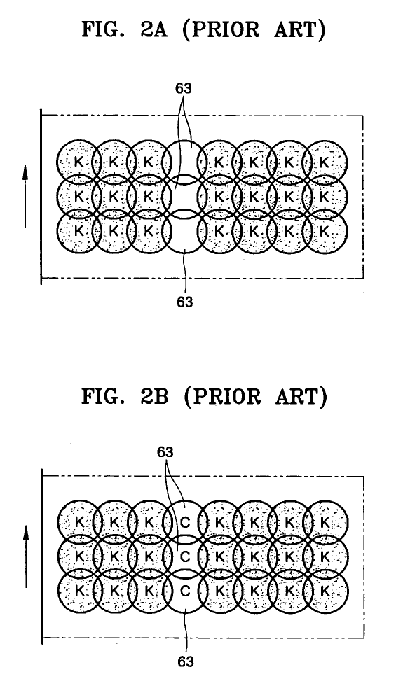

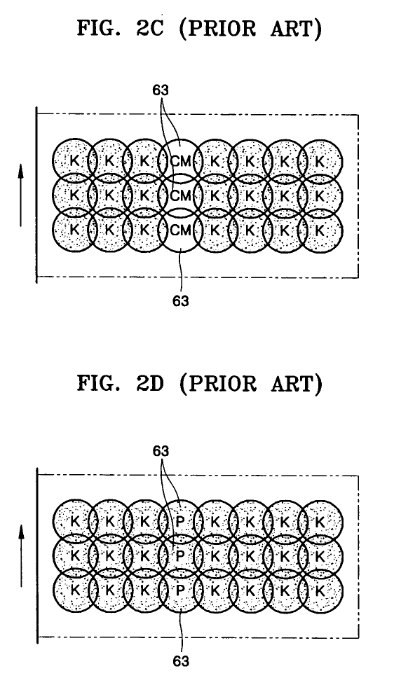

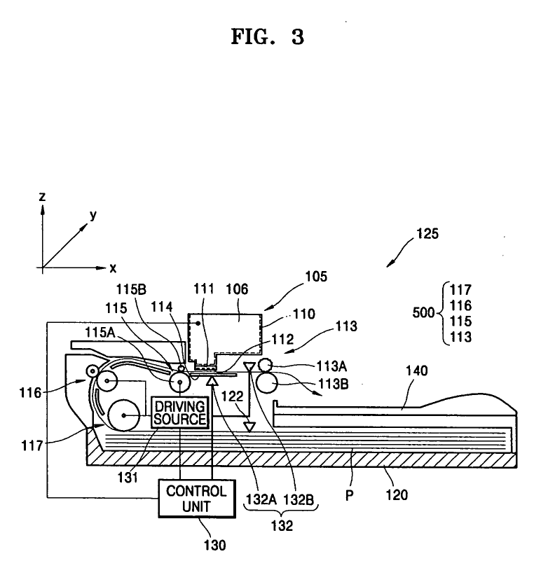

Referring to FIGS. 2, 10, 11, and 15, the image forming apparatus 125 receives the image data to be printed from the data input unit 135. As described above, the information about a malfunctioning nozzle in the nozzle unit 112 is detected by the malfunctioning nozzle detecting unit 132 and is stored in the memory (not illustrated) in operation S10. The information about the malfunctioning nozzle stored in the memory (not illustrated) is transmitted to the control unit 130. If a malfunctioning nozzle does not exist, the printing is performed according to a normal printing process in operation S15. On the other hand, if a malfunctioning nozzle exists, the printing process is varied according to the type of the print medium P.

The type of the print medium P may be confirmed by the information input from the print medium confirming unit (i.e., the print medium detecting unit 122 or the user interface 240) in operation S20, and the information about the type of the print medium P is also transmitted to the control unit 130. That is, when a malfunctioning nozzle exists, the manner in which the malfunctioning nozzle is compensated for is determined according to the type of the print medium P. For example, as described above, if the print medium P is plain paper, a single compensating solution droplet CD1 is ejected to compensate for the malfunctioning nozzle in operation S30, as illustrated in FIG. 16A. If the print medium P is photo paper or coated paper, a pair of compensating solution droplets CD1 and CD2 are ejected to compensate for the malfunctioning nozzle in operation S40, as illustrated in FIG. 16B. If the print medium P is a transparent film, large compensating solution droplets CD1 and CD2 are ejected to compensate for the malfunctioning nozzle in operation S50, as illustrated in FIG. 16C. After compensating for the malfunctioning nozzle according to the above described operations, a subsequent operation is determined according to whether the printing operation is finished in operation S60. If the printing operation is not finished yet, the printing operation is repeated according to the above described operations of compensating for the malfunctioning nozzle. On the other hand, if no pages to be printed remain, it is determined that the printing operation is finished.

As described above, in the method of compensating for a malfunctioning nozzle according to the type of the print medium P, a single compensating solution droplet is used for the compensation operation on plain paper, and a pair of compensating solution droplets are used for the compensation operation on photo paper, coated paper, or a transparent film. In addition, the type of the print medium P can be classified as photo paper, coated paper, and a transparent film. However, it should be understood that other variations of this embodiment may also be used with the present general inventive concept. For example, since the ink droplets deposited on the plain paper are large enough that a defect caused by a malfunctioning nozzle is typically not easily seen, the compensation solution need not be ejected to compensate for the malfunctioning nozzle when printing with plain paper. In other words, the control unit 130 may control the compensation nozzle unit 112 not to eject compensation solution when the malfunctioning nozzle is detected and the printing medium type is plain paper.

As described above, an inkjet image forming apparatus and a method of compensating for a malfunctioning nozzle according to embodiments of the present general inventive concept uses compensating solution droplets ejected from a compensating nozzle unit to compensate for the malfunctioning nozzle to prevent printing image degradation, such as an appearance of white lines that can be easily seen. In addition, nozzles of any color including a black color and other colors can be compensated for. The embodiments of the present general inventive concept can enhance the compensation operation by controlling sizes and arrangements of nozzles of a compensating nozzle unit thereof. Since the embodiments of the present general inventive concept do not use ink for the compensation operation, the use of the ink can be reduced and a lifespan of an inkjet printhead unit can be increased. The present general inventive concept can enhance the compensation operation using diffusion of the ejected ink with the compensating solution.

The present general inventive concept performs a printing operation by changing a compensation process based on a type of print medium (unlike conventional methods). Therefore, the embodiments of the present general inventive concept can print an image using a printing operation that corresponds to the type of the print medium, thereby realizing optimum printing quality.

The embodiments of the present general inventive concept detect a type of print medium using a print medium detecting unit installed in an image forming apparatus so that the image forming apparatus can print fast. The type of print medium is confirmed using a print medium confirming unit according to each printing environment so that the image forming apparatus can obtain optimal printing quality with respect to various printing environments.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A printhead, comprising:
a nozzle unit having a nozzle array to eject ink on a print medium to print an image and a length that corresponds to at least a width of the print medium; and
a compensating nozzle unit having a compensating nozzle array to eject a compensating solution on the print medium to compensate the image by diffusing the ink ejected from the nozzle unit and being installed parallel to the nozzle array in a direction perpendicular to a transferring direction of the print medium,
wherein each nozzle disposed in the compensating nozzle array is positioned at a predetermined position between nozzles disposed in the nozzle array.

2. The printhead of claim 1, wherein the position of each of the nozzles disposed in the compensating nozzle array is in a range of ¼ to ¾ of a gap between two adjacent nozzles disposed in the nozzle array.

3. The printhead of claim 1, wherein the position of each of the nozzles disposed in the compensating nozzle array is substantially at a center of a gap between two adjacent nozzles disposed in the nozzle array.

4. The printhead of claim 1, wherein diameters of the nozzles in the compensating nozzle array are greater than or equal to diameters of nozzles in the nozzle array, and less than or equal to twice the diameters of nozzles in the nozzle array.

5. The printhead of claim 1, wherein each of the nozzles disposed in the compensating nozzle array have an elliptical shape.

6. The printhead of claim 1, further comprising:
a plurality of head chips in which the nozzle unit and the compensating nozzle unit are formed longitudinally arranged in zigzag.

7. The printhead of claim 1, wherein the nozzle unit comprises a first nozzle array and a second nozzle array longitudinally arranged in parallel to each other and to eject the same color ink, and nozzles disposed in the first nozzle array and the second nozzle array are arranged to overlap with respect to each other along the transferring direction of the print medium.

8. The printhead of claim 1, wherein the compensating nozzle unit comprises a first compensating nozzle array and a second compensating nozzle array longitudinally arranged in parallel to each other and to eject the compensating solution, and nozzles disposed in the first compensating nozzle array and the second compensating nozzle array are arranged to overlap with respect each other along the transferring direction of the print medium.

9. A printhead, comprising:
at least one nozzle unit extending along a lengthwise direction of the printhead and having nozzles to eject ink; and
at least one compensating nozzle unit extending along the lengthwise direction of the printhead and having compensating nozzles to eject compensating solution to diffuse the ink, the compensating nozzles being alternatingly arranged with respect to the nozzles.

10. The printhead of claim 9, wherein each of the compensating nozzles is positioned adjacent to the adjacent nozzles of the nozzle unit in a widthwise direction of the printhead, and the compensating nozzle is disposed between the adjacent nozzles in the lengthwise direction of the printhead.

11. The printhead of claim 9, wherein the nozzles of the nozzle unit comprises first and second nozzles disposed adjacent to each other, the nozzles of the nozzle unit eject first and second adjacent ink droplets to a print medium, and one of the compensating nozzles of the compensating nozzle unit ejects a compensating solution droplet between the first and second adjacent ink droplets.

12. The printhead of claim 9, wherein:
the nozzles of the nozzle unit comprise first and second nozzles;
the compensating nozzles of the compensating nozzle unit comprise first and second compensating nozzles, first and second adjacent nozzles of the nozzle unit eject first and second adjacent ink droplets to a print medium, and the first and second compensating nozzles of the compensating nozzle unit eject first and second compensating solution droplets between the first and second adjacent ink droplets.

13. The printhead of claim 9, wherein a compensating nozzle of the compensating nozzle unit prints to a portion of a print medium that is slightly adjacent to a portion to which a malfunctioning nozzle of the nozzle unit fails to print.

14. An inkjet image forming apparatus, comprising:
a nozzle unit having a nozzle array to eject ink on a print medium to print an image and having a length that corresponds to at least a width of the print medium;
a compensating nozzle unit having a compensating nozzle array to eject a compensating solution on the print medium to compensate the image by diffusing the ink ejected from the nozzle unit and being installed parallel to the nozzle array in a direction that is perpendicular to a transferring direction of the print medium;
a printhead having the nozzle unit and the compensating nozzle unit mounted thereon such that each nozzle disposed in the compensating nozzle array is positioned at a predetermined position between adjacent nozzles disposed in the nozzle array;
a malfunctioning nozzle detecting unit to detect whether a malfunctioning nozzle exists in the nozzle unit; and
a control unit to drive the nozzles in the compensating nozzle unit when a malfunctioning nozzle is detected such that the ink ejected from nozzles adjacent to the malfunctioning nozzle in the nozzle unit diffuses toward the compensating solution ejected from the compensating nozzle unit, thereby compensating for the malfunctioning nozzle.

15. The inkjet image forming apparatus of claim 14, wherein the position of each of the nozzles disposed in the compensating nozzle array is in a range of ¼ to ¾ of a gap between the adjacent nozzles disposed in the nozzle array.

16. The inkjet image forming apparatus of claim 14, wherein the position of each of the nozzles disposed in the compensating nozzle array is substantially at a center of a gap between the adjacent nozzles disposed in the nozzle array.

17. The inkjet image forming apparatus of claim 14, wherein diameters of the nozzles in the compensating nozzle array are greater than or equal to diameters of the nozzles in the nozzle array, and less than or equal to twice the diameters of nozzles in the nozzle array.

18. The inkjet image forming apparatus of claim 14, wherein each of the nozzles disposed in the compensating nozzle array has an elliptical shape.

19. The inkjet image forming apparatus of claim 14, wherein the nozzle unit comprises a first nozzle array and a second nozzle array longitudinally arranged parallel to each other and to eject the same color ink, and nozzles disposed in the first nozzle array and the second nozzle array are arranged to overlap with respect to each other along the transferring direction of the print medium.

20. The inkjet image forming apparatus of claim 14, wherein the compensating nozzle unit comprises a first compensating nozzle array and a second compensating nozzle array longitudinally arranged parallel to each other and to eject the compensating solution, and nozzles disposed in the first compensating nozzle array and the second compensating nozzle array are arranged to overlap with respect to each other along the transferring direction of the print medium.

21. The inkjet image forming apparatus of claim 14, further comprising:
a print medium detecting unit to detect a type of the print medium and to provide information about the detected type of print medium to the control unit such that the control unit determines a compensation operation for a malfunctioning nozzle according to the detected type of the print medium.

22. The inkjet image forming apparatus of claim 14, further comprising:
a print medium confirming unit to confirm a type of the print medium and to provide information about the confirmed type of print medium to the control unit such that the control unit determines a compensation operation for a malfunctioning nozzle according to the confirmed type of the print medium.

23. An image forming apparatus, comprising:
a printhead having a plurality of nozzles and a plurality of compensating nozzles;
a print medium type unit to determine a type of print medium between at least a first type and a second type;
a malfunctioning nozzle detection unit to detect a malfunctioning nozzle of the printhead; and
a control unit to select a first compensation operation of the compensating nozzles when the first type of the print medium is detected and the malfunctioning nozzle is detected and a second compensation operation of the compensating nozzles when the second type of the print medium is detected and the malfunctioning nozzle is detected, and to operate the printhead accordingly.

24. The image forming apparatus of claim 23, wherein the compensating nozzles are arranged between the nozzles such that the compensating nozzles eject compensating solution between ink droplets ejected by the nozzles.

25. The image forming apparatus of claim 24, wherein each of the first and second compensation operations comprise one of:
an ejection of a droplet of the compensating solution between two adjacent ink droplets;
an ejection of two droplets of the compensating solution between the two adjacent ink droplets; and
an ejection of two droplets of the compensating solution that are larger than the two adjacent ink droplets.

26. An image forming apparatus, comprising:
a printhead having a plurality of nozzles and a plurality of compensating nozzles;
a print medium type unit to determine a type of print medium being used;
a printing environment information unit to receive printing environment variables including a print mode;
a malfunctioning nozzle detection unit to detect a malfunctioning nozzle of the printhead; and
a control unit to select a compensation operation from among a plurality of compensation operations based on the detected type of the print medium and the print mode, and to operate the printhead accordingly.

27. An image forming apparatus, comprising:
a printhead to print to a print medium, the printhead including a first plurality of nozzles to eject ink to a plurality of first portions of the print medium and a second plurality of nozzles to eject compensating solution to a plurality of second portions of the print medium; and
a control unit to control the printhead according to one or more printing environmental variables.

28. The image forming apparatus of claim 27, wherein the environmental variables comprise one or more of a state of a malfunctioning nozzle, a print mode, and a type of the print medium.

29. A method of compensating for a malfunctioning nozzle of an inkjet image forming apparatus which includes a printhead with a nozzle unit having a nozzle array with a length that corresponds to at least a width of a print medium and a compensating nozzle unit having a compensating nozzle array to eject a compensating solution on the print medium so as to diffuse ink ejected from the nozzle unit, the method comprising:
confirming a type of the print medium for printing;
detecting whether a malfunctioning nozzle exists in the nozzle unit using a malfunctioning nozzle detecting unit;
determining a compensation operation for the malfunctioning nozzle according to the confirmed type of the print medium when the malfunctioning nozzle exists; and
compensating for the malfunctioning nozzle by driving nozzles in the compensating nozzle unit such that the ink ejected from nozzles adjacent to the malfunctioning nozzle diffuses toward the compensating solution ejected from the compensating nozzle unit according to the confirmed type of the print medium.

30. The method of claim 29, wherein the confirming of the type of the print medium comprises detecting the type of the print medium using a print medium detecting unit having a light-emitting sensor and a light-receiving sensor.

31. The method of claim 29, wherein the confirming of the type of the print medium comprises receiving a confirmation command via a user interface to confirm the type of the print medium for printing.

32. A method of compensating for a malfunctioning nozzle in an image forming apparatus having a printhead with a plurality of nozzles and a plurality of compensating nozzles, a print medium type unit to determine a type of print medium between at least a first type and a second type, a malfunctioning nozzle detection unit to detect a malfunctioning nozzle of the printhead, the method comprising:
selecting a first compensation operation of the compensating nozzles when the first type of the print medium is detected and the malfunctioning nozzle is detected;
selecting a second compensation operation of the compensating nozzles when the second type of the print medium is detected and the malfunctioning nozzle is detected; and
driving the printhead according to the selected compensation operation.

33. The method of claim 32, wherein the compensating nozzles are arranged between the nozzles, and the driving of the printhead comprises driving the nozzles to eject ink droplets and driving the compensating nozzles to eject compensating solution between the ink droplets ejected by the nozzles.

34. The method of claim 33, wherein the driving of the printhead comprises:
ejecting two adjacent ink droplets from tow adjacent nozzles having a malfunctioning nozzle in between; and
performing one of ejecting a droplet of the compensating solution between the two adjacent ink droplets, ejecting two droplets of the compensating solution between the two adjacent ink droplets, and ejecting two droplets of the compensating solution that are larger than the two adjacent ink droplets.

35. A method of forming an image in an image forming apparatus having a printhead with a first plurality of nozzles that eject ink and a second plurality of nozzles that eject compensating solution, the method comprising:
ejecting ink to a plurality of first portions of the print medium via selected ones of the first plurality of nozzles; and
ejecting compensating solution to one or more second portions of the print medium via a selected one or more of the second nozzles when the first plurality of nozzles includes a malfunctioning nozzle.
